(19) United States
(12) Patent Application Publication
(10) Pub. No.: US 2015/0162983 A1
(43) Pub. Date: Jun. 11, 2015

(54) APPARATUS FOR THE OPTICAL TRANSMISSION OF DIGITAL DATA

(71) Applicant: Georg-Simon-Ohm Hochschule fur Angewandle Wissenschaften, Numberg (DE)

(72) Inventors: Hans Poisel, Nurnberg (DE); Olaf Ziemann, Nurnberg (DE); Alexander Bachmann, Nurnberg (DE)

(21) Appl. No.: 14/233,088

(22) PCT Filed: Jun. 21, 2012
(86) PCT No.: PCT/DE2012/000634

§ 371 Date: Sep. 4, 2014

(30) Foreign Application Priority Data
Jul. 15, 2011 (DE) 10 2011 110 707.3

(51) Int. Cl. H04B 10/2507; H04B 10/524; H04L 25/03; H04B 10/00

(52) U.S. Cl. CPC H04B 10/2507; H04B 10/225; H04B 10/524; H04L 25/03057

(57) ABSTRACT

The invention relates to an apparatus for the optical transmission of digital data having a signal source (1) which is designed to output optical signals at a level which is modulated on the basis of the digital data to be transmitted. The invention provides a fluorescing optical fiber (3) which is arranged such that the optical signals from the signal source (1) are received via a peripheral area which is entered by fluorescing optical fiber (3) which are converted therein into a fluorescent light signal by means of fluorescence, said fluororescent light signal being mounted to a fibre end (5) via the optical fibre (3).

The invention relates to an apparatus for optical transmission of digital data and a device in which such an apparatus is used.

In various applications, the problem those skilled in the art are confronted with is to maintain a data link between a rotating part and a stationary part, for example, in the case of a radar antenna or a computer tomograph. The axis of rotation should usually remain free because that is where the patient himself is placed when performing computer tomography, for example.

A variety of different approaches to this problem are known from the prior art. One of these approaches is described in DE 4421616 A, for example. In this prior art, a fluorescent optical fiber is bent to form a ring-shaped loop. The fiber itself is a conventional optical fiber, which is doped in a suitable way with a fluorescent dye, for example, rhodamine G, Nile blue or some other fluorescent dye.

If these fluorescent optical fibers are irradiated with light of a suitable wavelength, for example, 650 nm, then the dye contained in the optical fiber will absorb the radiation and omit light of a higher wavelength (Stokes shift). The emission occurs within the optical fiber and in all directions, so that some of the fluorescent light thereby emitted is directed along the optical fiber to its ends and can be detected there.

According to the prior art cited above, an optical signal originating from a signal source, for example, an LED or a laser diode is applied to such a fluorescent optical fiber from the side over its peripheral surface and this signal is also modulated according to the RZ or the NRZ pulse modulation scheme. In other words, a digital signal is transmitted by a discrete pulse, where an ON-state of the light may stand for 1 and an OFF-state of the light may stand for 0 or vice versa.

However, one problem with this technology is that fluorescent optical fibers require a decay time after being excited at a suitable wavelength, until the dye has dropped back to the ground state and a new excitation can occur. This means that the intervals between two successive light pulses must be longer than the decay time, which is in the range of 1 to 2.5 nanoseconds, depending on the dye selected.

As a result, the maximum frequency for data transmission is in the range of 500 MHz.

If larger volumes of data are to be transmitted, then a plurality of signal sources and a plurality of fluorescent optical fibers must be provided. However, this makes the system complex and expensive.

The object of the present invention is therefore to provide an apparatus for optical transmission of data in such a way as to overcome these disadvantages.

This object is achieved by an apparatus according to Claim 1 and a device according to Claim 7. The dependent claims relate to additional advantageous embodiments of the invention.

The invention is explained in detail below on the basis of the accompanying figures and preferred embodiments.

The figures show:

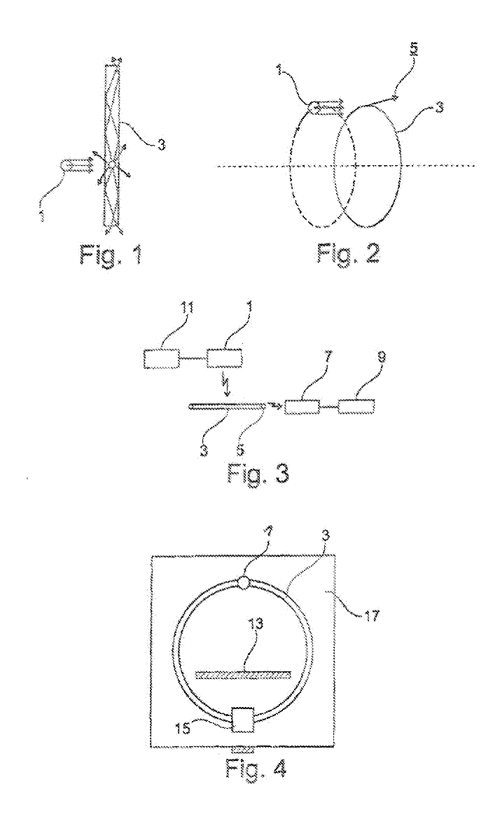

FIG. 1: the function principle of data transmission between a light source and a fluorescent optical fiber;

FIG. 2: a rough schematic design of a fiber-optic rotary transmitter having the apparatus according to the invention;

FIG. 3: a block diagram of the apparatus according to the invention;

FIG. 4: a cross section through a computer tomograph with the apparatus according to the invention.

The function principle of the fluorescent optical fiber is described in conjunction with FIG. 1. Light emitted by a suitable signal source 1 strikes the peripheral surface of a fluorescent optical fiber 3. A dye contained in the fluorescent optical fiber 3 absorbs some of this light and then in turn emits fluorescent light of a longer wavelength. With a suitable choice of the dye and the excitation wavelength, it is possible to minimize the partial overlap in the absorption spectrum and the emission spectrum, which usually occurs, so that there is only a minor self-absorption.

The emission process takes place with a time delay (the so-called fluorescence lifetime), which is typical for that dye and is usually within the range of a few nanoseconds, thus limiting the transmission bandwidth, as indicated previously.

Depending on the structure of the fluorescent optical fiber 3, specifically the numerical aperture, the diameter and the like, some of the light generated inside the fluorescent optical fiber 3 is captured therein and sent back to the peripheral surface by total reflection at both ends 5 of the fluorescent optical fiber 3, where it can be detected by a suitable method. The amount of radiation thereby guided is described by the so-called piping efficiency PE:

PE=1−nₘ/nₖ

where nₘ and nₖ denote the refractive indices of the fiber sheath and fiber core of the fluorescent optical fiber 3.

As illustrated in FIG. 2, it is advantageous in particular to bend the fluorescent optical fiber 3 in the form of a loop, so that it is concentric with an axis of rotation of a second component. A laser diode or an LED is provided as the optical signal source 1 on this second component and is mounted at a distance from the axis of rotation and is oriented, so that the light emitted by it strikes the fluorescent optical fiber 3 of the other component. If one of the two components is then rotating about the shared axis of rotation, a secure signal transmission between the two parts is nevertheless possible. FIG. 2 illustrates the principle of this data transmission.

As mentioned in the introduction, the amount of data to be transferred per unit of time (bandwidth and/or bit rate) in the known system is determined by the afterglow of the dye, i.e., the fluorescence lifetime. This varies in the nanosecond range with conventional dyes, for example, 2.5 nanoseconds for Styril 6, which limits the bit rate to 500 MHz with the known RZ or NRZ modulations. Another disadvantage is that a lower fluorescence yield is obtained when other dyes with a shorter fluorescence lifetime are selected, which leads to a worsened signal amplitude in the fluorescent optical fiber 3 and thus to a higher error rate in the data transmission.

This problem is solved according to the present invention by the fact that an amplitude-modulated optical signal is transmitted instead of a digital optical signal. This amplitude-modulated optical signal may be modulated either according to the known pulse amplitude modulation or according to the orthogonal frequency division multiplexing/discrete multitone modulation (OFDM/DMT). Other amplitude modulation techniques are also possible. The two modulation methods mentioned above are described briefly below.

In addition, according to the principle of pulse amplitude modulation, discrete light pulses are transmitted as in RZ or NRZ modulation. However, the amplitude of a transmitted pulse is adjusted in multiple stages, for example, 8 stages for transmission of 8 bits. In other words, the receiver cannot recover information corresponding to 1 bit from the amplitude of the transmitted pulse but instead can recover 8 bits by evaluation of the amplitude.

However, there are a number of problems here which result from the particular nature of the transmission in the system described above, in which the optical signal of the signal source is converted to fluorescent light within the optical fiber. These problems include essentially the lack of linearity between the excitation light and the fluorescent light, leading to a substantial signal distortion. It is surprising in this regard that it is possible to counteract this signal distortion through suitable predistortion or equalization on the receiver end.

Another problem arises due to the fluorescence lifetime already described above, which blurs the essentially sharp delineation in the excitation pulses. Furthermore, it should be noted that “memory effects” occur here, i.e., the strength of a fluorescence signal of a second light pulse of the signal source should not depend on the strength of the preceding first light pulse in an uncontrolled manner.

It should therefore be noted that according to the invention, the maximum intensity of the excitation light should be significantly below the saturation of the fluorescent optical fiber 3. In addition, the interval between two successive pulses should be large enough to ensure a reliable decay of the fluorescence. Ultimately it is helpful with this technique to use some of the additional data transmission bandwidth obtained for the transmission of correction information for error correction. Known techniques such as DFE (“decision feedback equalizing”) or FFE (“feed-forward equalizing”) can be used here.

FIG. 3 shows in this context a block diagram of the apparatus according to the invention.

In a data source (not shown), a digital signal is sent to a predistorter 11. In this predistorter 11, the digital signal is converted to an analog signal with a suitable pulse duration and pulse heights and is applied as an analog signal to signal source 1, for example, a laser diode or an LED. The optical signal emitted by the signal source 1 thus has a level which is modulated based on the digital data to be transmitted.

This optical signal falls on the peripheral surface of the fluorescent optical fiber 3, penetrates into the fluorescent optical fiber 3 and excites the fluorescent dye contained there to emit light of a second wavelength, which is longer than the excitation wavelength, as already described.

The signal level of the fluorescent light is a function of the signal level of the excitation light, but this relationship is not usually linear. Additional interfering effects such as the aforementioned self-absorption and attenuation in the optical fluorescent optical fiber 3 as a function of the different fiber lengths between the fiber end and the excitation site, in particular with a signal source and optical fiber moving relative to one another, result in further distortion of the signals, which ultimately arrive at one of the fiber ends 5, where they can be converted back to an electric signal by a suitable detector. An equalizer 9, which equalizes the received signal and converts it back into a digital signal, is expediently provided for the optical detector.

Predistorter 11 and equalizer 9 can transmit a preset bit sequence, and the predistortion and/or equalization may then be set so that this bit sequence can be restored on the receiver end. In addition, in particular with rotating systems, where the invention is preferably used, it is also possible to perform the predistortion and/or equalization as a function of the angle of rotation, so that the different fiber lengths and the associated impairment of the signal are compensated.

A second modulation technique, which permits even a much higher data transmission rate, is the orthogonal-frequency-division multiplexing/diecrete-multitone technique already mentioned above. In the known type of frequency division, several channels are modulated onto the optical signal of signal source 1. Each of these channels can then transmit one bit independently. With the known techniques, 256 or 512 channels are modulated. With these frequency multiplex methods, multiple signals are transmitted at the same time, distributed among several carriers. An orthogonal frequency multiplex method is preferred as an example of a multicarrier modulation. In a known type, the data to be transmitted is divided into multiple substreams of data, which have a lower bit data rate accordingly. These substreams of data are then modulated using known modulation methods such as the quadrature amplitude modulation method with a low bandwidth. The resulting higher frequency signals are then added up again and transmitted as an analog signal with amplitude modulation through signal source 1.

The optical signal of signal source 1 modulated in this way is converted to a corresponding fluorescence signal in the fluorescent optical fiber 3. This fluorescence signal, although in a distorted form, can nevertheless be restored and still contains the output information and can be converted back to the original output data by suitable demodulation and receiver circuits 7 and 9 at the end of the optical fiber.

In this modulation method, which no longer works by discrete light pulses, it is important in particular to be sure that the maximum amplitudes of the excitation light of the signal source as well as the highest modulation frequencies, are each low enough to keep memory effects in the fluorescent optical fiber 3 within limits, i.e., to prevent loss of information in the signal to be transmitted due to possible saturation of the fluorescence.

Transmission with this technique permits error correction information to be added to the original data in a known manner because of the much higher data transmission rate, so that the greater susceptibility to errors can be compensated by the larger volume of data to be transmitted, which leads to a higher useful data transmission rate when considered on the whole.

FIG. 4 shows the use of the invention in conjunction with a computer tomograph 17 as a system and/or device with which the apparatus according to the invention can be used to particular advantage. With a computer tomograph, large volumes of data must regularly be transmitted between a rotating part and a stationary part in a short period of time. Transmission via the axis of rotation is impossible here because the patient to be examined i.e., the bed 13 for the patient, is positioned in this location. Therefore, according to the invention, as illustrated in FIG. 4, a loop-shaped fluorescent optical fiber 3 is arranged on the stationary part of the computer tomograph, the end 5 of the fiber being connected to a suitable detector circuit 15.

This loop is designed to be concentric with the axis of rotation and is positioned at a distance from this axis of rotation, so there is enough room for the patient. A signal source 1, for example, an LED or a laser diode, is provided on the rotating part at a distance from the axis of rotation. This signal source emits light with a wavelength of 640 nanometers, for example, onto the peripheral surface of the fluorescent optical fiber 3.

The image information recorded by the rotating part of the computer tomograph is converted to digital data, converting it into an amplitude-modulated optical signal on the signal source 1 by the pulse-amplitude-modulation method or the multiple-frequency-multiplex method and then transmitted to the fluorescent optical fiber 3. In rotation of the rotating part, the light also always strikes the optical fiber 3. Since the relative angle between the rotating part and the stationary part is known, suitable compensation for the length of the optical fiber 3 can be achieved.

The optical signal of the signal source 1 is converted to fluorescent light in the fluorescent optical fiber 3 and is routed to the ends 5 of the optical fiber 3. A suitable detector 15, for example, a photocell or the like, converts the fluorescent light signal into an electric signal, which is then subjected to equalization and demodulation as well as to an analog-digital conversion. In this way, the digital image data is restored on the receiver end. Because of the high data transmission bandwidth made available by the device according to the invention, the image data can be transmitted with suitable error correction data, so that a secure, reliable and rapid data transmission is possible between the rotating part and the stationary part.

The invention has been described here with reference to preferred exemplary embodiments, but it is not limited to them. Instead of a computer tomograph, the invention may also be used to advantage in a radar antenna.

1. An apparatus for optical transmission of digital data, comprising:
a single source (1), which is equipped to output optical signals at a level modulated on the basis of the digital data to be transmitted, and
a fluorescent optical fiber (3), which is arranged to receive the optical signals from the single source (1) over a peripheral surface and is designed to fluoresce on reception of the optical signals of the signal source (1) and to route a fluorescent light signal in the optical fiber (3) to the fiber ends (5).

2. The apparatus according to claim 1, additionally comprising:
an equalizer (9), which is arranged to compensate for the distortion in the optical signals caused by the fluorescent optical fiber (3).

3. The apparatus according to claim 1, additionally comprising:
a predistorter (11), which is arranged to predistort the digital data for compensation of distortion of the transmission path.

4. The apparatus according to claim 2, designed to work according to the decision-feedback-equalizing technique and/or the feed-forward-equalizing technique.

5. The apparatus according to claim 2, wherein the signal source (1) is designed to modulate the optical signals according to the pulse-amplitude-modulation method or the orthogonal-frequency-division multiplexing/discrete-multitone technique.

6. The apparatus according to claim 2, wherein the signal source (1) and the fluorescent optical fiber (3) are designed to be movable relative to one another.

7. A device for transmission of digital data between two parts rotating relative to one another about a common axis, further comprising an equalizer (9), which is arranged to compensate for the distortion in optical signals caused by fluorescent optical fiber (3), wherein a signal source (1) is arranged on one part in the form of a ring around the axis of rotation and the fluorescent optical fiber (3) is arranged on the other part in the same way.

8. The devices according to claim 7, wherein the device is a computer tomography.

9. The devices according to claim 7, wherein the device is a radar device.

10. The apparatus according to claim 2, additionally comprising: a predistorter (11), which is arranged to predistort the digital data for compensation of distortion of the transmission path.

11. The apparatus according to claim 3, designed to work according to the decision-feedback-equalizing technique and/or the feed-forward-equalizing technique.

12. The apparatus according to claim 10, designed to work according to the decision-feedback-equalizing technique and/or the feed-forward-equalizing technique.

13. The apparatus according to claim 12, wherein the signal source (1) is designed to modulate the optical signals according to the pulse-amplitude-modulation method or the orthogonal-frequency-division multiplexing/discrete-multitone technique.

14. The apparatus according to claim 13, wherein the signal source (1) and the fluorescent optical fiber (3) are designed to be movable relative to one another.

15. The apparatus according to claim 14 being a device for transmission of digital data between two parts rotating relative to one another about a common axis, wherein the signal source (1) is arranged on one part in the form of a ring around the axis of rotation and the fluorescent optical fiber (3) is arranged on the other part in the same way.

16. An apparatus for optical transmission of digital data, comprising:
a single source (1), which is equipped to output optical signals at a level modulated on the basis of the digital data to be transmitted,
a fluorescent optical fiber (3), which is arranged to receive the optical signals from the single source (1) over a peripheral surface and is designed to fluoresce on reception of the optical signals of the signal source (1) and to route a fluorescent light signal in the optical fiber (3) to the fiber ends (5).
a device for transmission of digital data between two parts rotating relative to one another about a common axis, having an apparatus comprising an equalizer (9), which is arranged to compensate for the distortion in the optical signals caused by the fluorescent optical fiber (3), wherein the signal source (1) is arranged on one part in the form of a ring around the axis of rotation and the fluorescent optical fiber (3) is arranged on the other part in the same way.

17. The devices according to claim 18, wherein the device is a computer 16 tomography.

18. The devices according to claim 16, wherein the device is a radar device.
